(19) United States
(12) Patent Application Publication
(10) Pub. No.: US 2007/0005425 A1
(43) Pub. Date: Jan. 4, 2007

(54) METHOD AND SYSTEM FOR PREDICTING CONSUMER BEHAVIOR

(75) Inventors: Dominic Bennett, Los Altos, CA (US); Remigiusz K. Paczkowski, Belmont, CA (US)

Correspondence Address: CLARIA CORPORATION;c/o HAYNES BEFFEL & WOLFELD LLP, P.O. BOX 366, 751 KELLY STREET, HALF MOON BAY, CA, 94019, US

(73) Assignee: Claria Corporation, Redwood City, CA (US)

(21) Appl. No.: 11/427,226

(22) Filed: Jun. 28, 2006

Related U.S. Application Data
(60) Provisional application No. 60/694,533, filed on Jun. 28, 2005.

(51) Int. Cl. G06Q 30/00

(52) U.S. Cl. 705/14

(57) ABSTRACT

A method of predicting consumer response to given content. The process begins with the step of collecting a dataset of consumer response to the content, each data item including values for a selected set of segmentation variables related to past consumer behavior. The dataset contains at least twice the number of entries required to provide statistical validity. The process continues by constructing a classification tree structure using the dataset, in which the dataset is subdivided into learning and validation datasets of substantially equal size. Also, the criterion for each successive split is the lowest entropy of segmentation variables not employed to the point of such split. Each successive split of the learning dataset is performed only if that split produces child nodes statistically different from one another, and an identical split of the validation data set produces child nodes statistically similar to child nodes produced on the learning dataset. The system estimates consumer responses by first receiving a data item related to a new consumer, including values for the segmentation variables and then computing the likely response of the new consumer to the content, employing the classification tree data structure.

### RELATED APPLICATION

This application claims the benefit of U.S. Provisional Patent Application No. 60/694,533 entitled “Publishing Behavioral Observations to Customers” filed on Jun. 28, 2005. That application is incorporated by reference for all purposes.

### BACKGROUND OF THE INVENTION

The present invention relates generally to the field of market research, and in particular, it relates to the use of user behavior to define content offered to that user.

The science of economics is both complicated and inexact, precisely because human behavior is complex. While the question whether consumers will or will not respond to a particular advertisement by taking a desired action, generally purchasing or other wise, remains a matter governed more by intuition than science.

Market research as a discipline seeks to replace that intuition with objective judgments based on hard data, but to date that effort has not universally succeeded. Opinion pollsters are continually surprised by events, and multi-million dollar marketing campaigns completely fail.

A weakness of conventional marketing research is a lack of detailed information about actual consumer behavior leading up to a desired action. The fact needs no repetition that neither the general survey nor the focus group truly replicates consumer behavior. Rather, researchers need some method for knowing how real consumers behave in a real marketing setting.

The technique of gathering information about consumer behavior on the internet was set out in commonly-owned U.S. patent application Ser. No. 11/226,066, entitled “Method and Device for Publishing Cross-Network User Behavioral Data”filed on 14 Sep. 2005. (the “'066” Application). That application is incorporated by reference herein for all purposes.

The technique of the '066 Application teaches how information about user behavior on the internet can be gathered. In sum, that application teaches that a behavior module can reside on a user computer, which module can observe and record user behavior in terms of keystrokes, mouse clicks and so on. Also, the behavior module can also observe information about websites visited by the user. In conjunction with software incorporated into the behavior module, data about the web site or web page can be analyzed and the site categorized into one of a set of categories defined by the behavior module. Information identifying the category, as well as information about the user's navigation behavior, such as the when the site was visited, how much time was spent there, and what the user did, can also be gathered by the behavior module. Finally, the behavior module can summarize the information and compact it into a form suitable for transmission, such the form generally known as a “cookie.”

What is not taught by the '066 Application, and not seen in the art, is an understanding of how to employ such information to provide content to a user based on what that user wants to see. It remains to the present invention to provide such functionality to the art.

### SUMMARY OF THE INVENTION

An aspect of the invention is a method of predicting consumer response to given content. The process begins with the step of collecting a dataset of consumer response to the content, each data item including values for a selected set of segmentation variables related to past consumer behavior. The dataset contains at least twice the number of entries required to provide statistical validity. The process continues by constructing a classification tree structure using the dataset, in which the dataset is subdivided into learning and validation datasets of substantially equal size. Also, the criterion for each successive split is the lowest entropy of segmentation variables not employed to the point of such split. Each successive split of the learning dataset is performed only if that split produces child nodes statistically different from one another, and an identical split of the validation data set produces child nodes statistically similar to child nodes produced on the learning dataset. The system estimates consumer responses by first receiving a data item related to a new consumer, including values for the segmentation variables and then computing the likely response of the new consumer to the content, employing the classification tree data structure.

### BRIEF DESCRIPTION OF THE DRAWINGS

FIG. 1 illustrates the initial stages of an embodiment of the process set out in the claims appended hereto.

FIG. 2 continues the process of FIG. 1, depicting the detailed computation and analysis portions of the embodiment described.

FIG. 3 illustrates a binary tree constructed by the process depicted in FIG. 3.

FIG. 4 sets out a process for employing the process described above in a production environment to provide advertising content to users.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

The key problem facing marketers can be stated as follows: What is the probability that a specific customer will respond positively to a particular advertisement? More particularly, the problem can be stated thusly: Given an inventory of existing advertisements, and given information about a consumer's actual behavior, which advertisement has the highest probability of eliciting a positive response from the consumer?

Answering that question requires, first, that data regarding consumer behavior be gathered. Then, there must be provided a method for analyzing that data to relate it to the inventory of advertising material. Finally, that analysis must be harnessed to select and provide specific content to the user. In general, that process involves several parties: the user (or consumer) who is navigating the internet and is the target of the advertisement; the website operator, who provides the website content but not the advertising content; and the content provider, who selects and provides the actual advertisements.

The first requirement is the topic of the '066 Application. As explained there, one method for gathering behavioral information about consumers is to monitor behavior directly as the user navigates on the internet, via behavior monitoring software resident on the user's computer. Behavior can be identified in terms of a subject-matter context, and information can also be gathered based on whether the user filled out forms on a page, or clicked on an advertisement. Such behavior records can be kept, summarized, and reported.

The present invention concerns the second requirement, a process for analyzing data to relate past behavior to specific situations to produce a prediction of future action. One approach to that problem was illustrated in the embodiments set out in U.S. patent application Ser. No. 11/369,334 entitled “Method for Quantifying the Propensity to Respond to an Advertisement,” filed Mar. 7, 2006 by the inventors herein. A different approach is seen in the embodiments set out below.

Binary trees are a powerful technique for analyzing data, particularly large datasets in which the relationships among variables are not initially well understood. Generally, a binary tree is a data structure consisting of a set of linked nodes, in which each node has zero or two “child” nodes. Links are referred to as “branches,” and the final node on each branch is called the terminal or “leaf” node. Each node comprises a subset of the dataset, and the set of terminal nodes constitutes a partition of the dataset as a whole. Techniques and procedures involving binary trees in general are known in the art and will not be further addressed here.

The principles set out in the claims, below, are general in nature, but it is instructive to consider an exemplary embodiment of those principles. The embodiment set out here addresses the issues set out in the '066 Application, cited above. In general, the challenge can be stated as the requirement to select an advertisement to present to an internet user, representing the advertisement most likely to evoke a positive response from among the multiple advertisements available for display. Here, a “positive response” entails the user's clicking on an advertisement, resulting in navigation to another website, display of more detailed information, or similar behavior having commercial significance to the sponsor of the advertisement. That term may have different meanings in other environments in which different embodiments are deployed, as can be imagined by those in the art.

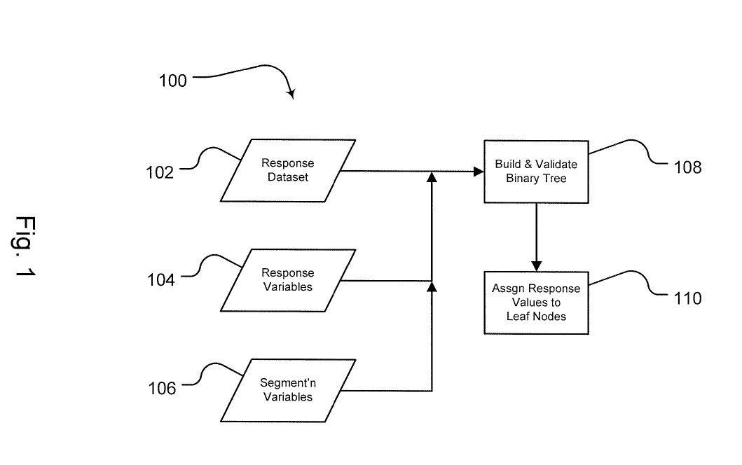

An overall process 100 embodying the principles claimed herein is illustrated in FIG. 1. Initially, three data gathering steps must be accomplished. First, the response dataset must be assembled (step 102). Then, the response variables and the segmentation variables must be selected (steps 104, 106). These initial steps are considered in the order presented.

Response data structures are specific to the application concerned, though they are governed by general principles. As described in the '066 Application, response data are gathered at the user's computer, based on both the user's navigation history (what websites were visited) and also the activity history (what was done at a visited site). In one embodiment, the content provider prepares for processing such data by first determining an extensive list of commercially relevant categories, and then it proceeds to categorize commercially relevant websites. That process is described in U.S. patent application Ser. No. 11/377,932, entitled “Method for Providing Content to an Internet User Based on the user's Demonstrated Content Preferences,” filed Mar. 16, 2006 and owned by the assignee herein. As noted there, categories should be defined at a relatively fine granularity level to provide useful information. In the embodiment discussed here, over 2000 categories are employed. As a user navigates the web, websites can be categorized by an appropriate module at the user's computer, or at a central location, via messages passing back and forth between such a central server and the user's computer.

The result of such activity is a record at the user's computer that includes recent internet activity, which can be represented by a data structure such as that shown in Table 1, below. As shown there, data can be aggregated by categories (indicated by a Category ID) and can include measures of how recently any activity occurred; a measure of how frequent the activity occurred; and the number of times that a banner was clicked, all further aggregated under the ID of the banner.

TABLE 1
Data from User

| Category ID | Recency | Frequency | Banner Clicks |
|---|---|---|---|
| 10494 | 3 | 4 | 1 |
| 98409 | 1 | 6 | 4 |
| 65625 | 14 | 6 | 3 |

Data such as that shown in Table 1 can be periodically provided to the content provider, either in the form of cookies or messages, as described in the '066 Application. In either event, data concerning activity for a particular user is made available to the content provider.

At the content provider level, activity data (concerning only a given period of time) can be combined with results from two other data sources. One source is geographic data, concerning the user computers location as well as any demographic data available about the user. Such data do not vary, and they can be stored at the content provider level and combined with incoming activity data as needed. Additionally, the content provider has information concerning the actually user response to an advertisement—did that user click on a given banner. That data is available separately, with the user's machine ID, and thus that data can be included.

From all the data received from users, combined with that from banner clicks, a dataset can be assembled for each banner ad, having the general structure shown in Table 2, as follows:

TABLE 2
Analysis data input

Category 1 recency
Category 1 frequency
Category 2 recency
Category 2 frequency
. . .
Category n recency
Category n frequency
Banner ID
Number of impressions
Number of clicks
Counter
Geographic data

It should be understood that the description above addresses a single user computer, but in practice a large number of user computers all send information to a central processing repository. It should also be understood that separate datasets are assembled for each banner advertisement, differing only in the identification of the advertisement concerned. As used below, the term “dataset” applies to data related to one advertisement.

Choosing the response variables (step 104) requires an identification of the response desired from the user. In one embodiment, any click on the presented advertisement qualifies as a target event. Other embodiments go further and require that the user not only click on the advertisement, but also take some action after doing so, such as subscribing to the resulting website, or the like. For analytical purposes, either approach is permissible, but the content provider must think through this problem in advance.

The initial step in designing a system using binary trees is selecting the variables employed in splitting nodes, known as segmentation variables (step 106). Often, the selection of variables flows from the dataset itself. In the embodiment set out herein, the variables include category recency, category usage, and others discussed above. An associated issue is the representation of variable values. Many variables exhibit a range of values, a situation which demands choices of how to characterize such values for analysis purposes. It has been found useful to define buckets for such values, which allows the designer to draw lines based on the applied (rather than intrinsic) value of the data. Table 3, below, sets but the segmentation variables employed herein, together with the value characterizations. As seen there, the Category Recency variable is divided into reporting buckets that have greatly different lengths. The most recent time values are emphasized in this structure, as one can readily understand the value to a marketer of knowing that a consumer visited a given website only five minutes previously.

TABLE 3
Segmentation Variables

| Split | | |
|---|---|---|
| Characteristic | Values | Remarks |
| Category | 15 recency buckets | Cumulative splits i.e. |
| recency | within 2,000 possible | split 1 = (recency = 1) |
| | categories | Split 2 = (recency = 1, 2) |
| | 0-5 min | Split 3 = (recency = 1, 2, 3) |
| | 5-15 min | etc |
| | 15-30 min | |
| | 30-60 min | |
| | 1-2 hrs | |
| | 2-4 hrs | |
| | 4-12 hrs | |
| | 12-24 hrs | |
| | 1-3 days | |
| | 3-7 days | |
| | 7-14 days | |
| | 14-21 days | |
| | 21-30 days | |
| | 30-45 days | |
| | 45-60 days | |
| Category | 7 usage buckets | Cumulative splits |
| usage | within 2,000 possible | Split 1 = (usage = 1) |
| | categories | Split 2 = (usage = 1, 2) |
| | 1 days | etc |
| | 2 days | |
| | 3 days | |
| | 4 or 5 days | |
| | 6 to 10 days | |
| | 11 to 30 days | |
| | 31 to 60 days | |
| Placement | List of placements | Cumulative split post |
| | | ordering in descending |
| | | sequence by response |
| | | variable values |
| US vs | Is this machine | |
| International | a US machine or an | |
| | International Machine | |
| Region Code | List of geographic | Cumulative split post |
| | regions | ordering in descending |
| | | sequence by response |
| | | variable values |
| Country Code | List of country | Cumulative split post |
| | codes | ordering in descending |
| | | sequence by response |
| | | variable values |
| MSA Code | List of | Cumulative split post |
| | metropolitan | ordering in descending |
| | statistical areas | sequence by response |
| | | variable values |
| DMA code | List of direct | Cumulative split post |
| | marketing | ordering in descending |
| | association area | sequence by response |
| | | variable values |
| Zipcode | List of zipcodes | Cumulative split post |
| | | ordering in descending |
| | | sequence by response |
| | | variable values |
| Ad frequency | 1, 2, 3 values based | Cumulative splits |
| | on the ad-frequency | Split 1 = (ad-freq = 1) |
| | cookie | Split 2 = (ad-freq = 1, 2) |
| | | Etc |
| New to brand | 0 = never clicked | |
| | on that advertiser | |
| | before (based on the | |
| | ad-info cookie) | |
| | 1 = has clicked on | |
| | the advertiser before | |

Two points should be made about the segmentation variables employed for this embodiment. First, several of the variables are actually clusters of variables. Thus, for example, the variable Category Recency is actually some 2000 variables, one for each category, so that an actual category would be, for example, Airline Reservation Recency, measuring the time elapsed since the user has accessed a site in that category. Second, the nature of the problem indicates that selection of a segmentation variable value operates to split the population of a node into two groups. Thus, when analyzing the populations of child nodes resulting from a given split, or proposed split, one node will consist of those elements having a value less than the segmentation variable value, and the other node all elements with values equal to or greater than that value. For example, if one were considering a split employing the segmentation variable “Airline Reservation Category Usage”,at a value of 3 days, then one node would consist of the cumulation of the buckets labeled “1 day” and “2 days”, and the other the contents of buckets labeled “3 days,” “4 or 5 days,” “6 to 10 days,” “11 to 30 days,” and “31 to 60 days.”

Also, it should be noted that some segmentation variables might not be ordinal in nature. Locations, for example, do not lend themselves to ordered lists such as used for time variables. Here, some arbitrary element can be used to signify a split point, such as zipcode, other codes, or simply the position of a value on a list. So long as the listing produces consistent results, the technique for such ordering can be set up as desired.

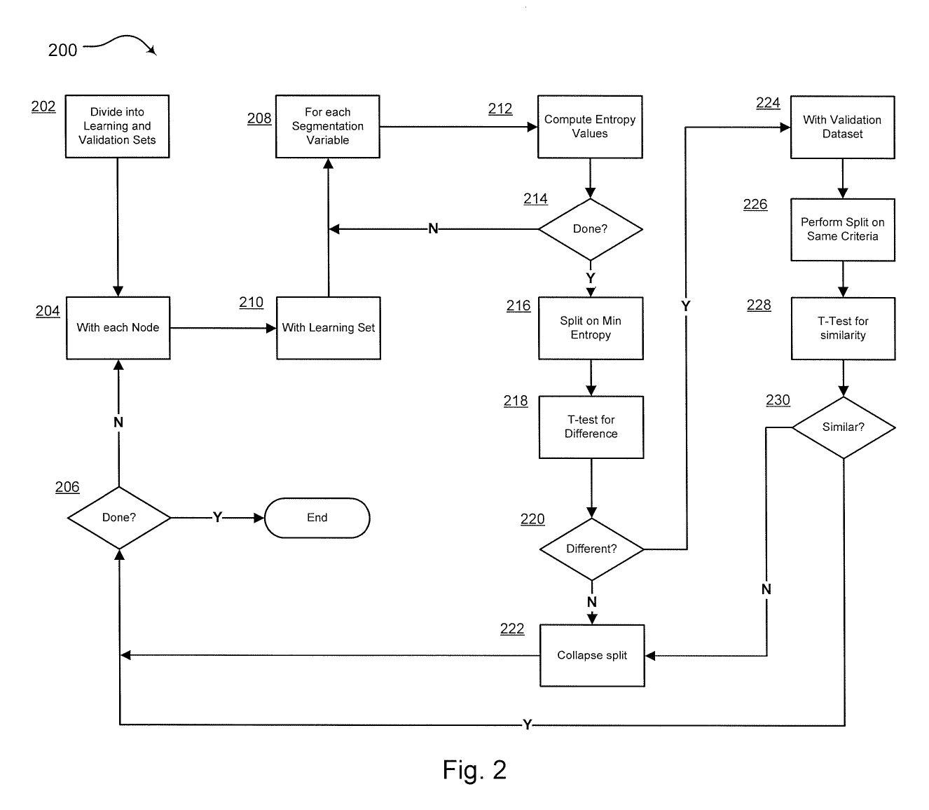

These data form inputs to the process of building and validating a binary tree, step 108. FIG. 2 illustrates an embodiment 200 of this process. The first action, step 202, consists of dividing the dataset into two subsets, a learning set and a validation set. These sets should be indistinguishable to the extent possible, and the selection criterion should be chosen with a view to avoiding the introduction of any biasing factors.

The general process of building a binary tree is known in the art and will not be set out in any detail here. Rather, the discussion that follows will build on conventional techniques by concentrating on those additions and improvements that characterize the claimed process.

Tree building proceeds on a node-by-node basis, with testing and validation accomplished on the fly. Analysis of each node, in step 204, starts with the learning set, in step 210. The segmentation variable is selected and tested empirically, by examining results for each possible segmentation value, step 212. For each possible value of each possible segmentation value (step 208) (see below), the system proceeds to calculate an entropy value, in step 212.

As used here, “entropy” refers to “information entropy”, defined as
Entropy=−[R log₂R+(1−R)log₂R]
where R is the response variable, expressed as a percentage rate. That equation provides calculates the entropy of the complete dataset of a given node. The entropy of a given split depends on the sum of the entropies of each child node dataset (conventionally referred to as “Right” and “Left” nodes), as follows:
Entropy_{L}=−[R_{L} log₂R_{L}+(1−R_{L})log₂R_{L}]
Entropy_{R}=−[R_{R} log₂R_{R}+(1−R_{R})log₂R_{R}]
It has been found that superior results are obtained by performing a split at the segmentation variable value that provides the minimum entropy level after the split. Thus, the splitting criterion can be expressed as follows:

$$min [ \frac{{n}_{L}}{{n}_{L} + {n}_{R}} {Entropy}_{L} + \frac{{n}_{R}}{{n}_{L} + {n}_{R}} {Entropy}_{R} ]$$

where n is the number of observations in a given node.

Those principles can be put into practice as follows. At a given node, an iterative process is performed to calculate the net entropy for every value of every available segmentation variable (see below) (step 214). The segmentation variable yielding the lowest entropy level is selected, and the split is performed, at step 216.

The split is then subjected to a two-part test to ensure validity and robustness. The first question to be addressed is whether the split should be made at all, which is addressed by determining the statistical difference between the populations of the two child nodes. That difference is measured by performing a statistical T-test to compare the two child nodes, step 218. That test is known in the art and will not be set out in detail here. The results of that test indicate whether any statistical difference exists between the two child nodes, step 220. If no difference exists, then the split does not improve the analytical product of the binary tree, and the parent node in question should be treated as a terminal, or leaf, node. The proposed split is collapsed, step 222, and the process loops back to consider other nodes.

It should be noted at this point that the directions, or rules, for performing each node split are saved to provide a set of directions for replicating the binary tree. A number of possible structures for this process are known in the art, and details of the same can be left to the discretion of skilled practitioners.

If the split does produce useful results, then the process proceeds to validate the split, using the validation dataset, in step 224. There, the binary tree constructed using the learning dataset is replicated using the validation dataset, to the point at which the loop starting at step 210 had proceeded, and then the split made at step 216 is replicated with the validation dataset. At this point the question is whether the validation dataset tree is the same as or similar to the learning set tree, which again can be addressed with a statistical T-test. Instead of looking for difference, the T-test here looks for similarity, step 228. A positive finding confirms the validity of the tree structure, step 230, and the process loops back, retaining the newly-split node in the tree. If the T-test does not show similarity, the split is collapsed, step 222, before looping back.

The loop starting at step 204 and continuing to steps 222 or 230, terminates at step 206, where it is determined whether to perform another loop or end the process. The process continues until every node is determined to be a leaf node, or until a predetermined number of node levels has been reached. Both of these criteria are sufficiently known in the art to require no further explanation here. If the process does commence another loop, the segmentation variable used in the previous loop is declared unavailable for further use, precluding the selection of that variable for any other nodes. Thus, if a loop of the process employs “Airline Reservation Recency” as a segmentation variable, that variable cannot be used on any other nodes of the tree.

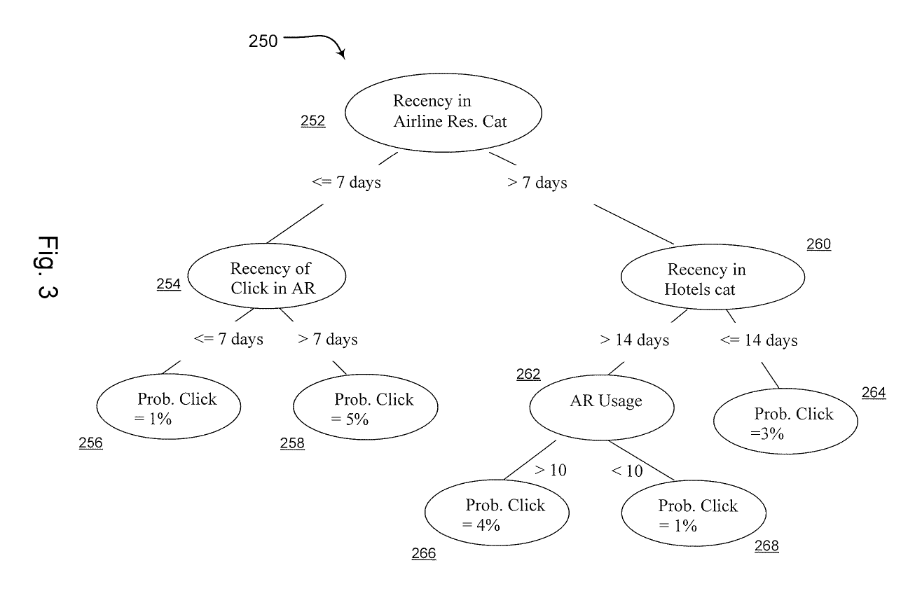

A binary tree 250, constructed according to the principles set out in the embodiment described above, is shown in FIG. 3. The root node 252 was found to yield minimum entropy using a segmentation variable of recency in the Airline Reservation category, at a value of less than or equal to 7 days. Thus, child nodes 254 and 260 contain all entries for which activity in the Airline Reservations category was reported within the previous 7 days and beyond that period, respectively. At node 254, the minimum entropy was found using the recency of click in the Airline Reservation category, at a value of less than or equal to 7 days. The two child nodes 256 and 258 from that point, however, were found to be terminal, or leaf, nodes, and have no child nodes below them. The fact that a node is found to be a terminal node does not imply that other nodes at the same level are also terminal nodes. As can be seen, node 264 is a terminal node, but node 262 is not.

The set of terminal nodes constitutes a complete portioning of the dataset. Here, nodes 256, 258, 266, 268 and 264 are the terminal nodes. It will be noted that because the splitting rules are based on varied crieteria, no implication exists of size of the populations in the nodes. Rather, the nodes report on behavior correlations of commercial interest.

It is also possible to calculate the response variable rate of the population of a terminal node, as that data is included in the response dataset (as shown in FIG. 1, step 110). Here, the response variable is chosen to be the click rate, and the percentage click rate is shown for each terminal node. This latter step allows one to draw useful inference from the tree. Thus, one can see that the sample indicates that a person who had navigated to a website dealing with airline reservations in the previous week, and had clicked on an item in such a site over a week ago would have a 5% probability of clicking on the advertisement under consideration. If that person had clicked on an airline reservations site item within the past week, that person would have only a 1% probability of clicking on the advertisement.

The “response rate” calculation can be tailored to the business environment of the content provider. For example, if the content provider is compensated by advertiser client based on a set value per click on an advertisement, then that value can be incorporated directly into the tree calculation. If, for example, the compensation was set at $1.00 per click, then showing the advertisement in question to a user who fits into node 258 has an expected return of $.05, which showing the ad to a user from node 256 can be expected to return only $.01. Those in the art can adapt the principles set out above to fit whatever compensation plans that may be devised. For example, if compensation is tied to some more detailed response than a simple click, such as subscription to a site, or an actual purchase, that criterion is straightforwardly added to the data collected, and the results are reflected in each terminal node.

Using the process set out above, a tree is constructed for every advertisement in the operator's inventory. Those in the art will be able to determine appropriate intervals for refreshing these data and the resulting trees, in order to ensure the data remain valid and to identify any emerging trends. Also, as new advertisements are developed, they can be offered initially on a test basis, to gather sufficient data to enable the construction of a binary tree, and afterward they can enter a normal production cycle. These and other details of managing the use of such trees are within the skill of those in the art.

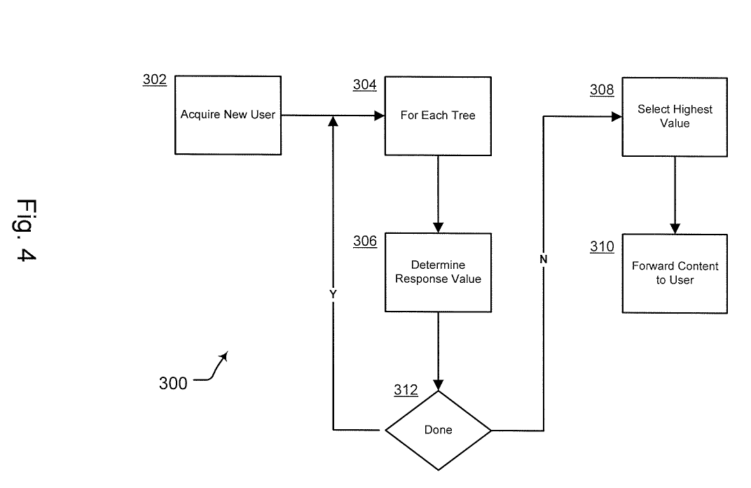

process 300 for employing the embodiment discussed above in a production environment is shown in FIG. 4. There, a new user is acquired at step 302, and the task is to determine what content to provide. The loop consisting of steps 304, 306 and 312 determines the advertisement having the highest value for the user in question. That result is determined by iterating through every binary tree in the inventory (step 304); at each stage the system uses the user profile to identify the terminal node into which the user fits, and then calculates a value for displaying the associated advertisement to the user. This step 306 is carried out exactly as set out above. When completed, at step 312, that process allows the system to select the highest value advertisement, at step 308, and to forward that advertisement to the user, step 310.

While the present invention is disclosed by reference to the preferred embodiments and examples detailed above, it is understood that these examples are intended in an illustrative rather than in a limiting sense. Computer-assisted processing is implicated in the described embodiments. It is contemplated that modifications and combinations will readily occur to those skilled in the art, which modifications and combinations will be within the spirit of the invention and the scope of the following claims.

We claim as follows:

1. Method of predicting consumer response to given content, including the steps of
collecting a dataset of consumer response to the content, each data item including values for a selected set of segmentation variables related to past consumer behavior and the dataset containing at least twice the number of entries to provide statistical validity;
constructing a classification tree structure using the dataset, wherein
the dataset is subdivided into learning and validation datasets of substantially equal size;
the criterion for each successive split is the lowest entropy of segmentation variables not employed to the point of such split; and
each successive split of the learning dataset is performed only if such split produces child nodes statistically different from one another; and
an identical split of the validation data set produces child nodes statistically similar to child nodes produced on the learning dataset;
receiving a data item related to a new consumer, including values for the segmentation variables;
computing the likely response of the new consumer to the content, employing the classification tree data structure.

2. The method of claim 1, wherein the segmentation variables include data relating to internet navigation history of the consumer.

3. The method of claim 1, wherein the segmentation variables include information related to categories of websites visited by the consumer.

4. The method of claim 1, wherein the subdivision of the dataset is made on the basis of a variable independent of the segmentation variables or the consumer response.

5. The method of claim 1, further including the step of calculating the value of the consumer response to the provider of the content.

6. The method of claim 1, wherein the process is repeated for a plurality of content items, producing a library of classification data structures.

7. Method of predicting consumer response to given content presented in connection with viewing a website on the internet, including the steps of
collecting a dataset of consumer response to the content, each data item including values for a selected set of segmentation variables related to past consumer internet behavior, the dataset containing at least twice the number of entries to provide statistical validity;
constructing a classification tree structure using the dataset, wherein
the dataset is subdivided into learning and validation datasets of substantially equal size;
the criterion for each successive split is the lowest entropy of segmentation variables not employed to the point of such split; and
each successive split of the learning dataset is performed only if such split produces child nodes statistically different from one another; and
an identical split of the validation data set produces child nodes statistically similar to child nodes produced on the learning dataset;
receiving a data item related to a new internet consumer, including values for the segmentation variables;
computing the likely response of the new consumer to the content, employing the classification tree data structure.

8. The method of claim 7, wherein the segmentation variables include data relating to internet navigation history of the consumer.

9. The method of claim 7, wherein the segmentation variables include information related to categories of websites visited by the consumer.

10. The method of claim 7, wherein the subdivision of the dataset is made on the basis of a variable independent of the segmentation variables or the consumer response.

11. The method of claim 7, further including the step of calculating the value of the consumer response to the provider of the content.

12. The method of claim 7, wherein the process is repeated for a plurality of content items, producing a library of classification data structures.

13. A classification tree data structure useful for predicting consumer response to given content, wherein the tree structure is constructed by a process including the steps of
subdividing the dataset into learning and validation datasets of substantially equal size;
determining each successive split based on the lowest entropy of segmentation variables not employed to the point of such split; and
performing successive split of the learning dataset only if
such split produces child nodes statistically different from one another; and
an identical split of the validation data set produces child nodes statistically similar to child nodes produced on the learning dataset.

14. The classification tree structure of claim 13, wherein the segmentation variables include data relating to internet navigation history of the consumer.

15. The classification tree structure of claim 13, wherein the segmentation variables include information related to categories of websites visited by the consumer.

16. The classification tree structure of claim 13, wherein the subdivision of the dataset is made on the basis of a variable independent of the segmentation variables or the consumer response.

17. The classification tree structure of claim 13, further including the step of calculating the value of the consumer response to the provider of the content.

18. Method of predicting consumer response to given content, including the steps of
assembling a library of binary tree tools, including the steps of
building a consumer response dataset, including the steps of
exposing consumers to selected content;
collecting each consumer response, measured as a value of a response variable;
collecting consumer segmentation characteristics, measured as values of each of a set of consumer segmentation variables;
continuing the collection until the dataset consists of at least twice the number of data items required for a statistically valid sample;
dividing the dataset into a learning set and a validation set, based on a variable independent of either the response variable or any segmentation variable, the datasets being substantially equal in size and each being sufficiently large to provide statistical reliability;
constructing a binary tree by successively splitting nodes, each splitting step including the steps of
employing the learning dataset to obtain a proposed split, including
splitting the node hypothetically, based on each value of each segmentation variable;
calculating the entropy of each hypothetical split;
choosing the split having the minimum entropy as the proposed split;
performing a statistical test on the resulting nodes to determine whether they differ statistically;
collapsing the proposed split in the event no difference is found;
validating the proposed split, including
replicating the proposed split on the validation dataset;
performing a statistical test on the resulting nodes to determine whether they are statistically similar to like nodes of the proposed split;
collapsing the proposed split in the event that no similarity is found;
continuing the tree construction process, with each successive split employing only those segmentation variables not employed in an adopted split;
receiving data concerning an individual consumer, including values for the set of segmentation variables;
determining the most appropriate content to present to the consumer, including the steps of
obtaining a value for the consumer dataset for each binary tree tool in the library; and
selecting the content associated with the binary tree tool producing the highest response value.
